(19) United States
(12) Patent Application Publication
(10) Pub. No.: US 2023/0368526 A1
(43) Pub. Date: Nov. 16, 2023

(54) SYSTEM AND METHOD FOR PRODUCT SELECTION IN AN AUGMENTED REALITY ENVIRONMENT

(71) Applicant: GOOGLE LLC, Mountain View, CA (US)

(72) Inventor: Omar Estrada Diaz, Sacramento, CA (US)

(21) Appl. No.: 17/662,974

(22) Filed: May 11, 2022

(51) Int. Cl. G06V 20/20; G06V 10/74; G06F 3/01; G06V 10/94; G06F 3/16

(52) U.S. Cl. CPC G06V 20/20; G06V 10/74; G06F 3/013; G06V 10/945; G06F 3/167; G06F 3/04847

(57) ABSTRACT

A system and method includes a computing system that captures images of multiple objects and/or entities in the physical environment, and that identifies the objects/entities in the captured images. The computing system retrieves information related to the identified objects/entities, and outputs the information to a user of the computing system. The computing system may access information locally and/or from external resources in the identification of the multiple objects/entities and in the retrieval of the related information. The information to be output by the computing system may be selected in response to a user input, or based on set user preferences or known user data. The output of information related to the multiple objects/entities may allow a user of the computing system to compare the multiple objects/entities and make an informed decision related to the selection of one or more of the objects/entities without the need for multiple individual searches.

### BACKGROUND

Users of mobile computing devices, such as, for example, wearable computing devices such as smart glasses, smart watches and the like, handheld computing devices such as smartphones, tablet computing devices and the like, may like to use their mobile computing devices to learn more about objects, entities and the like in the environment in which the user, and the mobile computing device is operating. Mobile computing devices may include various sensors, communication capabilities, access to external resources and the like that collect data that may be indicative of a user's interest in objects, entities and the like in the physical environment. In some situations, the user may use one or more of these mobile computing devices to access additional information related to the objects/entities of interest by, for example, conducting individual searches related to the various objects/entities. While this approach may eventually yield the information the user seeks, this may be cumbersome and/or time consuming and/or inconvenient. A system and method that provides information to the user without relying on user-initiated, individual searches related to the objects/entities may provide enhanced functionality and utility to the user.

### SUMMARY

In one general aspect, a computer-implemented method includes capturing, by an image sensor of a computing device, images of a physical environment; obtaining, from a recognition engine in communication with the computing device, identification of a plurality of physical objects detected in the images; obtaining, from a search engine in communication with the computing device, information related to the plurality of physical objects identified in the images; and outputting, by an output system of the computing device, the information related to the plurality of physical objects identified in the images, the information providing a comparison of at least one common characteristic of the plurality of physical objects identified in the images.

In some examples, obtaining the identification of the plurality of physical objects detected in the image includes detecting an identification condition; and transmitting the images to an external system via a network in response to the identification condition, wherein the recognition engine is provided at the external system, the external system having access to a plurality of databases from which the recognition engine obtains identifying information associated with the plurality of physical objects.

In some examples, detecting the identification condition may include at least one of detecting a gaze directed at the plurality of physical objects having a duration that is greater than or equal to a set threshold; or detecting, by the computing device or an external device that is in communication with the computing device, a user input initiating identification of the plurality of physical objects, the user input including at least one of an audible input detected by an audio sensor of the computing device or the external device, a touch input detected by a touch sensor of the computing device or the external device, or a gesture input detected by at least one of an image sensor or a position sensor of the computing device or the external device.

In some examples, outputting the information related to the plurality of physical objects identified in the images may include detecting an output condition; and generating, for display by a display device of the computing device, a plurality of virtual objects including the information providing the comparison of the at least one common characteristic of the plurality of physical objects in response to the output condition. The information included in the plurality of virtual objects may be obtained by at least one search engine of the external system based on the identifying information associated with the plurality of physical objects.

In some examples, detecting the output condition and outputting the information may include detecting a first user input setting the at least one common characteristic for comparison; detecting a second user input requesting output of the information providing the comparison of the at least one common characteristic of the plurality of physical objects; and displaying the plurality of virtual objects in response to the second user input.

In some examples, the first user input and the second user input may be audible inputs detected by an audio sensor of the computing device and transcribed, by a transcription engine in communication with the computing device, into a command that is executable by the computing device.

In some examples, detecting the output condition and outputting the information may include setting the at least one common characteristic based on at least one of set user preferences or known user data; detecting a gaze directed at the plurality of physical objects; detecting a duration of the gaze that is greater than or equal to a set threshold; and displaying the plurality of virtual objects in response to detecting the duration of the gaze that is greater than or equal to the set threshold.

In some examples, outputting the information related to the plurality of physical objects includes setting a first common characteristic for comparison of the plurality of physical objects; and triggering for display, by a display device of the computing device, a first plurality of virtual objects respectively corresponding to the plurality of physical objects, the first plurality of virtual objects displaying the information related to the plurality of physical objects for comparison of the first common characteristic of the plurality of physical objects.

In some examples, setting the first common characteristic may include at least one of setting the first common characteristic in response to a user input selecting the first common characteristic; setting the first common characteristic based on set preferences for a user of the computing device; or setting the first common characteristic based on known user data associated with the user of the computing device.

In some examples, the computer-implemented method also includes receiving, from an external system, the information related to the plurality of physical objects for comparison of the first common characteristic of the plurality of physical objects, wherein the information is obtained by at least one search engine of the external system having access to at least one database; and generating, for display by a display device of the computing device, the first plurality of virtual objects, the first plurality of virtual objects displaying the information obtained by the at least one search engine for comparison of the first common characteristic of the plurality of physical objects.

In some examples, the computer-implemented method also includes setting a second common characteristic for comparison of the plurality of physical objects; obtaining, from the external system, additional information obtained by the at least one search engine related to the plurality of physical objects for comparison of the second common characteristic of the plurality of physical objects; and generating, for display by the display device of the computing device, a second plurality of virtual objects, the second plurality of virtual objects displaying the additional information obtained by the at least one search engine for comparison of the second common characteristic of the plurality of physical objects.

In some examples, outputting the information related to the plurality of physical objects may include setting the at least one common characteristic for comparison of the plurality of physical objects; and outputting, by an audio output device of the computing device, an audio signal including the information related to the plurality of physical objects for comparison of the at least one common characteristic of plurality of objects.

In some examples, the computing device is a head mounted wearable computing device, or a handheld computing device.

In another general aspect, a system includes a computing device, the computing device including a display device; at least one processor; and a memory storing instructions. When executed by the at least one processor, the instructions cause the at least one processor to capture, by an image sensor of a computing device, images of a physical environment; obtain, from a recognition engine in communication with the computing device, identification of a plurality of physical objects detected in the images; obtain, from a search engine in communication with the computing device, information related to the plurality of physical objects identified in the images; and output, by an output system of the computing device, the information related to the plurality of physical objects identified in the images, the information providing a comparison of at least one common characteristic of the plurality of physical objects identified in the images.

In some examples, the instructions cause the at least one processor to detect an identification condition; transmit the images to an external system in response to the identification condition, wherein the recognition engine is provided at the external system, the external system having access to a plurality of databases including identifying information associated with the plurality of physical objects; and obtain the identification of the plurality of physical objects detected in the images from the external system.

In some examples, the instructions cause the at least one processor to detect the identification condition including at least one of detect a gaze directed at the plurality of physical objects having a duration that is greater than or equal to a set threshold; or detect, by the computing device or an external device in communication with the computing device, a user input initiating identification of the plurality of physical objects, the user input including at least one of an audible input detected by an audio sensor of the computing device or the external device, a touch input detected by a touch sensor of the computing device or the external device, or a gesture input detected by at least one of an image sensor or a position sensor of the computing device or the external device.

In some examples, the instructions cause the at least one processor to output the information related to the plurality of physical objects identified in the images, including detect an output condition; and generate, for display by the display device, a plurality of virtual objects including the information providing the comparison of the at least one common characteristic of the plurality of physical objects in response to the output condition. The information included in the plurality of virtual objects may be obtained by at least one search engine of the external system based on the identifying information associated with the plurality of physical objects.

In some examples, the instructions cause the at least one processor to detect the output condition and to output the information, including detect a first user input setting the at least one common characteristic for comparison; detect a second user input requesting output of the information providing the comparison of the at least one common characteristic of the plurality of physical objects; and display the plurality of virtual objects in response to the second user input.

In some examples, the first user input and the second user input may be audible inputs detected by an audio sensor of the computing device and transcribed, by a transcription engine in communication with the computing device, into a command that is executable by the at least one processor of the computing device.

In some examples, the instructions cause the at least one processor to detect the output condition and to output the information, including set the at least one common characteristic based on at least one of set user preferences or known user data; detect a gaze directed at the plurality of physical objects; detect a duration of the gaze that is greater than or equal to a set threshold; and display the plurality of virtual objects in response to detecting the duration of the gaze that is greater than or equal to the set threshold.

In another general aspect, a non-transitory computer-readable medium stores executable instructions. When executed by at least one processor of a computing system, the executable instructions cause the at least one processor to capture, by an image sensor of a computing device of the computing system, images of a physical environment; obtain, from a recognition engine in communication with the computing device, identification of a plurality of physical objects detected in the images; obtain, from a search engine in communication with the computing device, information related to the plurality of physical objects identified in the images; and output, by an output system of the computing device, the information related to the plurality of physical objects identified in the images, the information providing a comparison of at least one common characteristic of the plurality of physical objects identified in the images.

In some examples, the instructions cause the at least one processor to detect an identification condition; transmit the images to the recognition engine in response to the identification condition, wherein the recognition engine is provided external to the computing device, the recognition engine accessing a plurality of databases including identifying information associated with the plurality of physical objects; obtain the identification of the plurality of physical objects detected in the images from the external system; detect an output condition; and generate, for display by a display device of the computing device, a plurality of virtual objects including the information providing the comparison of the at least one common characteristic of the plurality of physical objects in response to the output condition. The information included in the plurality of virtual objects is obtained by at least one search engine that is external to the computing device based on the identifying information associated with the plurality of physical objects.

In some examples, the instructions cause the at least one processor to detect the identification condition including at least one of detect a gaze directed at the plurality of physical objects having a duration that is greater than or equal to a set threshold; or detect, by the computing device or an external device in communication with the computing device, a user input initiating identification of the plurality of physical objects, the user input including at least one of an audible input detected by an audio sensor of the computing device or the external device, a touch input detected by a touch sensor of the computing device or the external device, or a gesture input detected by at least one of an image sensor or a position sensor of the computing device or the external device. In some examples, the instructions cause the at least one processor to detect the output condition and to output the information, including detect a first user input setting the at least one common characteristic for comparison; detect a second user input requesting output of the information providing the comparison of the at least one common characteristic of the plurality of physical objects; and display the plurality of virtual objects in response to the second user input.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example system, in accordance with implementations described herein.

FIGS. 1B-1D illustrate example computing devices that can be used in the example system shown in FIG. 1A.

FIG. 2 is a block diagram of an example system configured to implement the concepts described herein.

FIGS. 3A-3H illustrate an example operation conducted by an example computing device, in accordance with implementations described herein.

FIGS. 4A-4H illustrate an example operation conducted by an example computing device, in accordance with implementations described herein.

FIG. 5 is a flowchart of an example method, in accordance with implementations described herein.

FIG. 6 shows an example of a generic computer device and a generic mobile computer device.

### DETAILED DESCRIPTION

Users may use a number of different types of computing devices to access information related to objects and/or entities in the physical environment. Such computing devices may include, for example, for example, handheld computing devices (smartphones and the like), wearable computing devices such as hand and/or wrist worn computing devices (smart watches, smart bracelets, smart rings and the like), head mounted computing devices (smart glasses, goggles, headsets and the like), ear worn computing devices, neck worn lanyard computing devices, other mobile computing devices (tablet computing devices, laptop computing devices and the like). In some examples, the user may use one or more of these types of computing devices to, for example, conduct a search for additional information related to the objects and/or entities in the physical environment. In some situations, the user may wish to access additional information related to multiple different objects and/or entities observed in the physical environment, substantially simultaneously and/or in real time. The information may provide a comparison of one or more common characteristics of the objects and/or entities. The information provided for each of the objects and/or entities may allow the user to analyze the information and make an informed decision selection from amongst the multiple the objects and/or entities. Conducting individual searches for the comparison information related to the common characteristics of each of the multiple objects and/or entities, collecting and/or tabulating the additional information, and referring back to the individually collected information may be cumbersome and time consuming for the user, particularly in a situation in which the user is using a mobile computing device to actively collect the additional information and make an informed decision in real time. A system and method that provides for the identification of the objects and/or entities, and that provides additional, relevant information to the user in connection with the objects and/or entities, may enhance the functionality of these types of devices.

Systems and methods, in accordance with implementations described herein, may use data collected by one or more sensors of a computing device to identify objects and/or entities in the physical environment. The one or more sensors may include, for example, image sensors such as cameras, audio sensors such as microphones, location sensors, position and/or orientation sensors, and other such sensors. Systems and methods, in accordance with implementations described herein, may access information related to the identified objects and/or entities. In some examples, the information is available from data stored on the computing device. In some examples, the information is available in an external database that is accessible to the computing device. In some examples, the information provides a comparison of the objects and/or entities, using the one or more common characteristics as a basis for the comparison, so that the objects and/or entities may be compared on a consistent basis.

In some examples, the one or more common characteristics may be based on a standard of measurement that may provide for differentiation amongst the objects/entities. In some examples, the common characteristic may be based on a quantifiable standard of measurement that is based on, for example, the composition of the object. In some examples, this may include, for example, nutritional components of the object. In some examples, this may include, for example, cost of the object. In some examples, this may include, for example, weight of the object. In some examples, this may include, for example, dimensions of the object. In some examples, this may include numerous other such quantifiable standards of measurement having to do with the composition of the object. In some examples, the common characteristic may be based on a standard of measurement that is determined based on data obtained in relation to the object. In some examples, this may include, for example, rating data. In some examples, this may include, for example, popularity data. In some examples, this may include, for example, origin/production data. In some examples, such standards of measurement may include other data that is descriptive of the objects, and that may serve as a basis for comparison of the objects, or a discriminator amongst the objects.

Systems and methods, in accordance with implementations described herein, may present the information related to multiple objects and/or entities in the physical environment substantially simultaneously, to provide for comparison amongst the multiple objects and/or entities. The presentation to the user of the information related to the multiple objects and/or entities at substantially the same time may allow the user to make an informed decision related to the multiple objects and/or entities substantially in real time, based on a comparison of common characteristics, without relying on individual manual/user implemented searches for relevant information related to the identified objects and/or entities. In some examples, the information is accessed and provided by the system in response to a user request. In some examples, the system may access and provide the information in an anticipatory manner, based on a set user profile, user preferences and/or history, and other such factors.

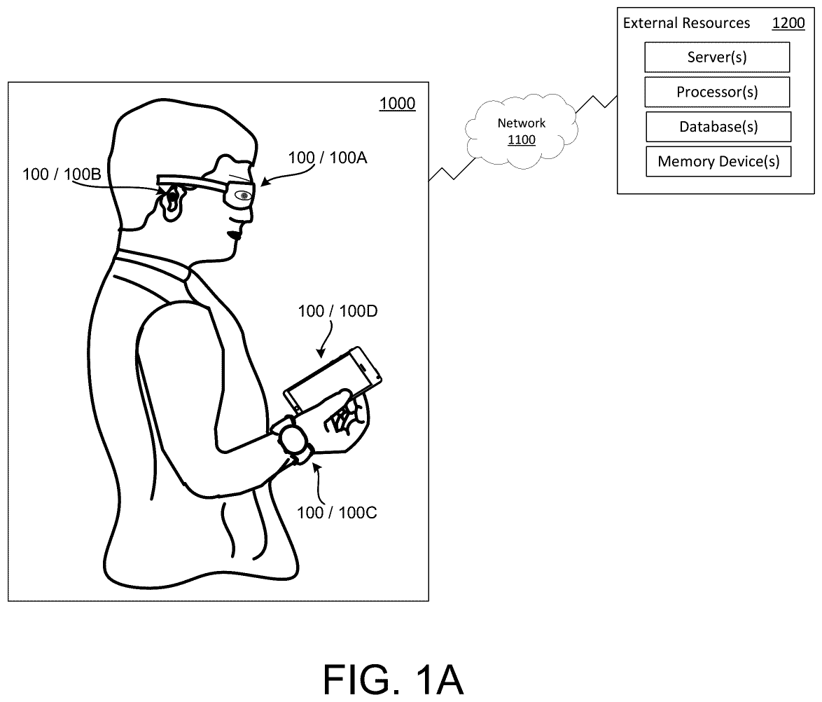

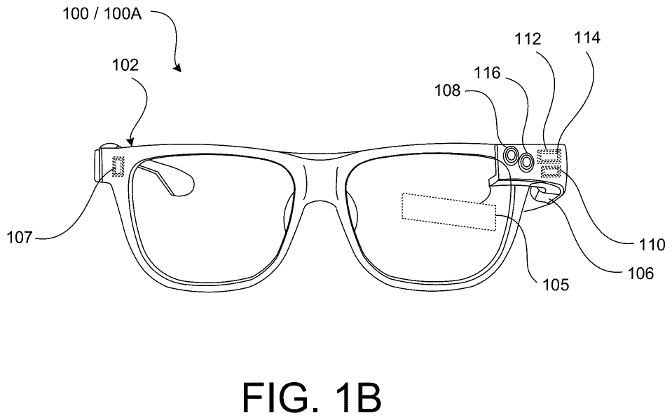

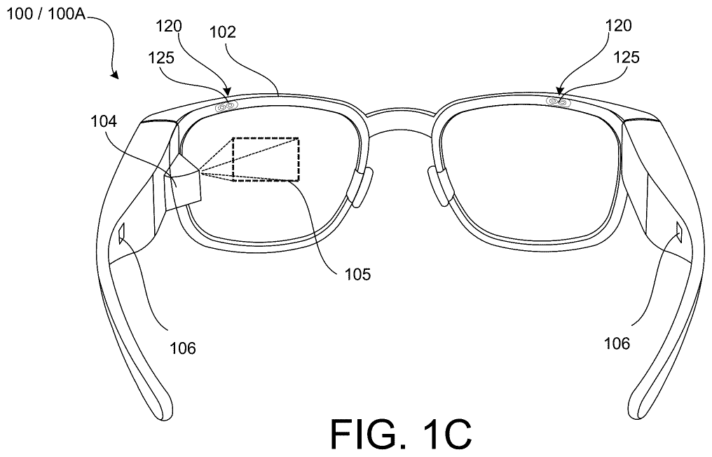

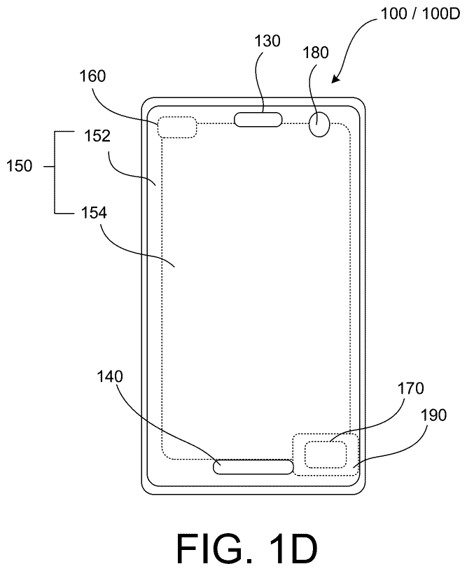

FIG. 1A illustrates a user in a physical environment 1000, with multiple different example mobile computing devices 100 that may be used by the user in the physical environment 1000, including wearable computing devices and handheld computing devices. In the example shown in FIG. 1A, the example mobile computing devices 100 include a first computing device 100A in the form of an example head mounted display (HMD) device, or smart glasses, a second computing device 100B in the form of an example wrist worn device, or a smart watch, a third computing device 100C in the form of an example ear worn device, or ear bud(s), and a fourth computing device 100D in the form of an example handheld computing device, or smartphone. The example computing devices 100 shown in FIG. 1A may be connected and/or paired so that they can communicate with, and exchange information with, each other. In some examples, the example computing devices 100 shown in FIG. 1A may access external resources 1200 via a network 1100.

FIG. 1B is a front view, and FIG. 1C is a rear view, of the first computing device 100A in the form of smart glasses. FIG. 1D is a front view of the fourth computing device 100D in the form of a smartphone. Hereinafter, example systems and methods will be described with respect to the use of the example computing device 100 in the form of the head mounted wearable computing device shown in FIG. 1B and/or the handheld computing device in the form of the smartphone as shown in FIG. 1C, simply for purposes of discussion and illustration. The principles to be described herein may be applied to other types of mobile computing devices, including the mobile computing devices 100 shown in FIG. 1A, and other mobile computing devices not specifically shown.

As shown in FIGS. 1B and 1C, the first computing device 100A in the form of the head mounted wearable computing device, or smart glasses, includes a frame 102 having rim portions surrounding lens portions, with arm portions rotatably coupled to the rim portions. In some examples, a display device 104 is coupled in one or both of the arm portions of the frame 102, to display content to the user within an eye box 105. In some examples, the first computing device 100A can also include an audio output device 106 (for example, one or more speakers), an audio input device 107 (for example, a microphone), an illumination device 108, a sensing system 110, a control system 112, at least one processor 114, and an outward facing image sensor 116 (for example, a camera). In some examples, the display device 104 may include a see-through near-eye display. For example, the display device 104 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world next to digital images (e.g., user interface elements, virtual content, etc.) generated by the display device 104. In some examples, waveguide optics may be used to depict content for output by the display device 104.

The sensing system 110 may include various sensing devices and the control system 112 may include various control system devices to facilitate operation of the computing device 100A including, for example, one or more processors 114 operably coupled to the components of the control system 112. In some examples, the control system 112 may include a communication module providing for communication and exchange of information between the computing device 100A and other external devices.

In some examples, the image sensor 116 may be an outward facing camera, or a world facing camera that is capable of capturing still and/or moving images of external objects in the physical environment within a field of view of the image sensor 116. In some examples, the image sensor 116 may be a depth camera that can collect data related to distances of the external objects from the image sensor 116. In some examples, the illumination device 108 may selectively operate, for example, with the image sensor 116, for detection of objects in the field of view of the image sensor 116.

In some implementations, the computing device 100A includes a gaze tracking device 120 including, for example, one or more image sensors 125. The gaze tracking device 120 may detect and track eye gaze direction and movement. Images captured by the image sensor(s) 125 may be processed to detect and track gaze direction and movement, and to detect gaze fixation. In some examples, the detected gaze may be processed as a user input to be translated into a corresponding interaction with external objects in the physical environment 1000 that are visible to the user through the lens portions of the computing device 100A and/or interaction with objects displayed to the user by the display device 104.

FIG. 1D is a front view of the fourth computing device 100D in the form of a smart phone held by the user in FIG. 1A. The fourth computing device 100D may include an interface device 150. In some implementations, the interface device 150 may function as an output device, including, for example, a display portion 152, allowing the interface device 150 to output information to the user. In some implementations, the interface device 150 may function as an input device, including, for example, a touch input portion 154 that can receive, for example, touch inputs from the user. In some implementations, the interface device 150 can function as an input device and an output device. In some implementations, the computing device 100D includes an audio output device 130 (for example, a speaker). In some implementations, the computing device 100D includes an audio input device 140 (for example, a microphone) that detects audio signals for processing by the computing device 100D. In some implementations, the computing device 100D includes an image sensor 180 (for example, a camera), that can capture still and/or moving images in the field of view of the image sensor 180. The computing device 100D may include a sensing system 160 including various sensing system devices. The computing device 100D may include a control system 170 including various control system devices and a processor 190, to facilitate operation of the computing device 100D.

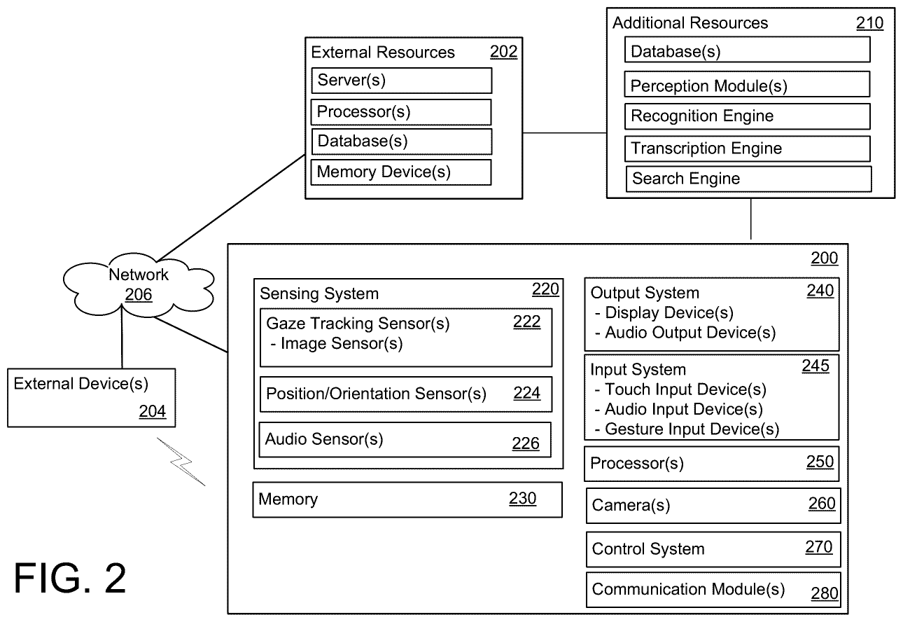

FIG. 2 is a block diagram of an example system including an example computing device 200, in accordance with implementations described herein. In the example system shown in FIG. 2, the example computing device 200 may be, for example, one of the example mobile computing devices 100 (100A, 100B, 100D, 100D) shown in FIG. 1A and described in more detail with respect to FIGS. 1B-1D. The example computing device 200 may be another type of computing device not specifically described above, that can detect user input, which can output content to the user, and other such functionality so as to be operable in the disclosed systems and methods.

In the example arrangement shown in FIG. 2, the computing device 200 can communicate selectively via a network 206 to access external resources 202. The external resources may include, for example, server computer systems, processors, databases, memory storage, and the like. The computing device 200 can operate under the control of a control system 270. The computing device 200 can communicate with one or more external computing devices 204 (another wearable computing device, another mobile computing device, an external controllable device, and the like) either directly (via wired and/or wireless communication), or via the network 206. The computing device 200 can include a communication module 280 to facilitate external communication. In some implementations, the computing device 200 includes a sensing system 220 including various sensing system components including, for example one or more gaze tracking sensors 222 including, for example image sensors, one or more position/orientation sensor(s) 224 including for example, an inertial measurement unit, accelerometer, gyroscope, magnetometer and the like, and one or more audio sensors 226 that can detect audio input. The computing device 200 can include more, or fewer, sensing devices and/or combinations of sensing devices.

In some implementations, the computing device 200 may include an output system 240 including, for example, one or more display devices that can display still and/or moving image content and one or more audio output devices that can output audio content. In some implementations, the computing device 200 may include an input system 245 including, for example, one or more touch input devices that can detect user touch inputs, an audio input device that can detect user audio inputs, a gesture input device that can detect user gesture inputs (i.e., via image detection, via position detection and the like), and other such input devices. In some implementations, the computing device 200 may include one or more camera(s) 260. The camera(s) 260 may be, for example, outward facing, or world facing cameras that can capture still and/or moving images of an environment outside of the computing device 200. The still and/or moving images may be displayed by the display device of the output system 240 and/or transmitted externally via the communication module 280 and the 206, and/or stored in a memory 230 of the computing device 200. The computing device 200 may include one or more processors 250, which may be formed in a substrate configured to execute one or more machine executable instructions or pieces of software, firmware, or a combination thereof. The processor(s) 250 can be semiconductor-based that include semiconductor material that can perform digital logic. The memory 230 may include any type of storage device that stores information in a format that can be read and/or executed by the processor(s) 250. The memory 230 may store applications and modules that, when executed by the processor(s) 250, perform certain operations. In some examples, the applications and modules may be stored in an external storage device and loaded into the memory 230.

In some implementations, the computing device 200 may access additional resources 210 to, for example, facilitate the identification of objects and/or entities captured within the field of view of the computing device 200, to search for and obtain additional information related to the identified objects and/or entities, and the like. In some implementations, the additional resources 210 may be accessible to the computing device 200 via the network 206 and/or within the external resources 202. In some implementations, the additional resources may be available within the computing device 200. The additional resources 210 may include, for example, one or more databases and/or and one or more processing algorithms. In some implementations, the additional resources may include, for example, a perception module that provides for two dimensional visual tracking (for example, of objects detected within the field of view of the camera 260), three dimensional pose estimation, six-degree-of-freedom pose estimation (for example, of objects detected within the field of view of the camera 260), and the like. In some implementations, the additional resources may include a recognition engine, providing for identification of objects and/or entities captured within the field of view of the camera 260. In some implementations, the additional resources 210 may include representation databases including, for example, visual patterns associated with objects, relationships between various objects, and the like. In some implementations, the additional resources may include a search engine to facilitate searching associated with identifying objects and/or entities captured within the field of view of the camera 260, obtain additional information related to the identified objects, and the like. In some implementations, the additional resources may include a transcription engine, providing for transcription of detected audio commands for processing by the control system 270 and/or the processor(s) 250.

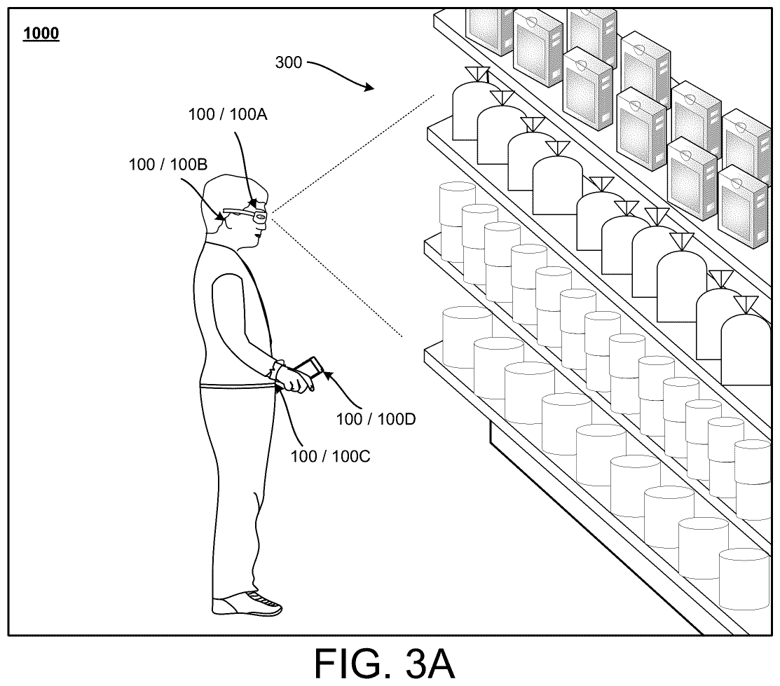

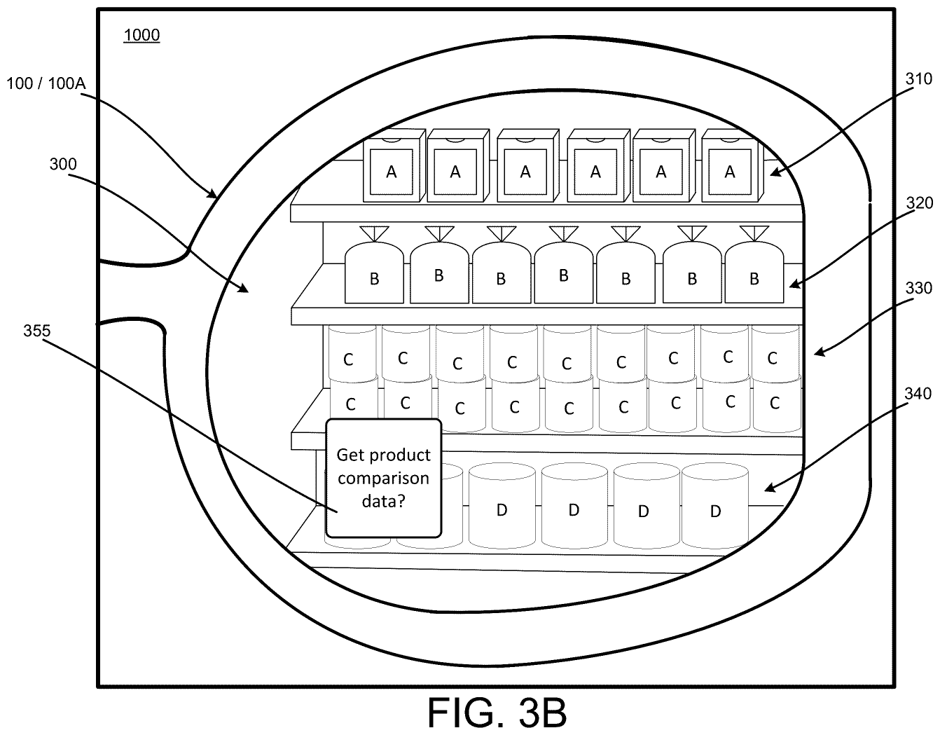

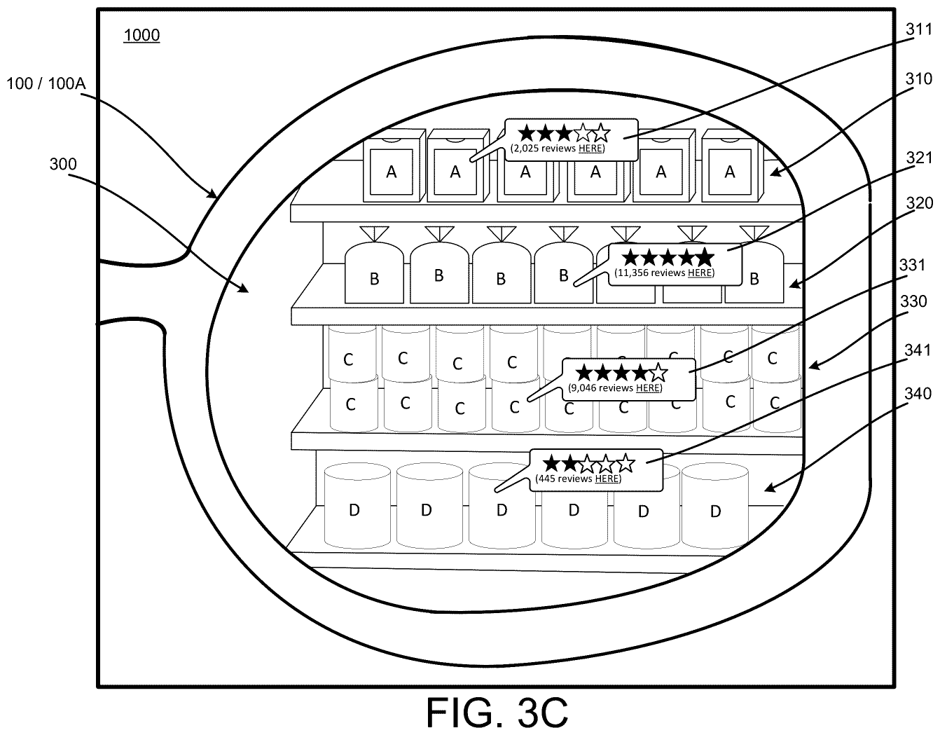

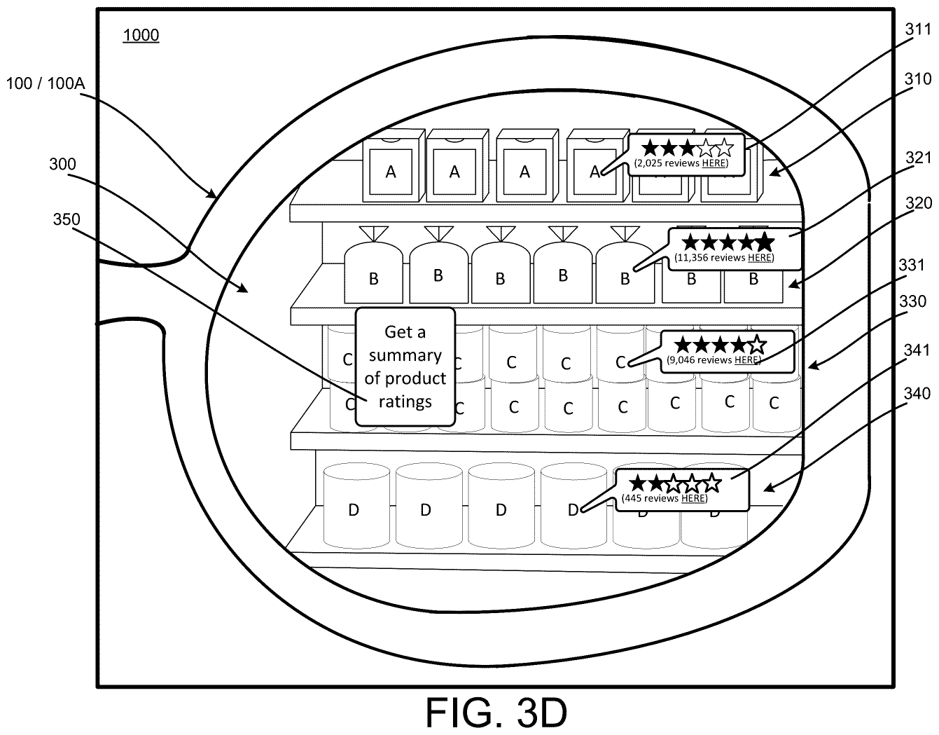

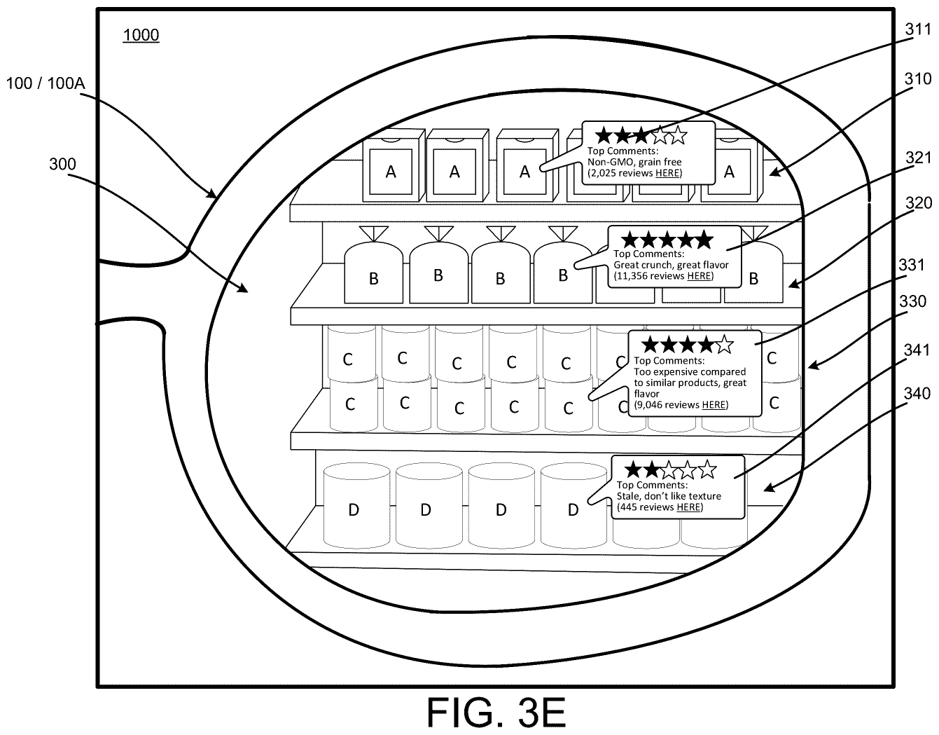

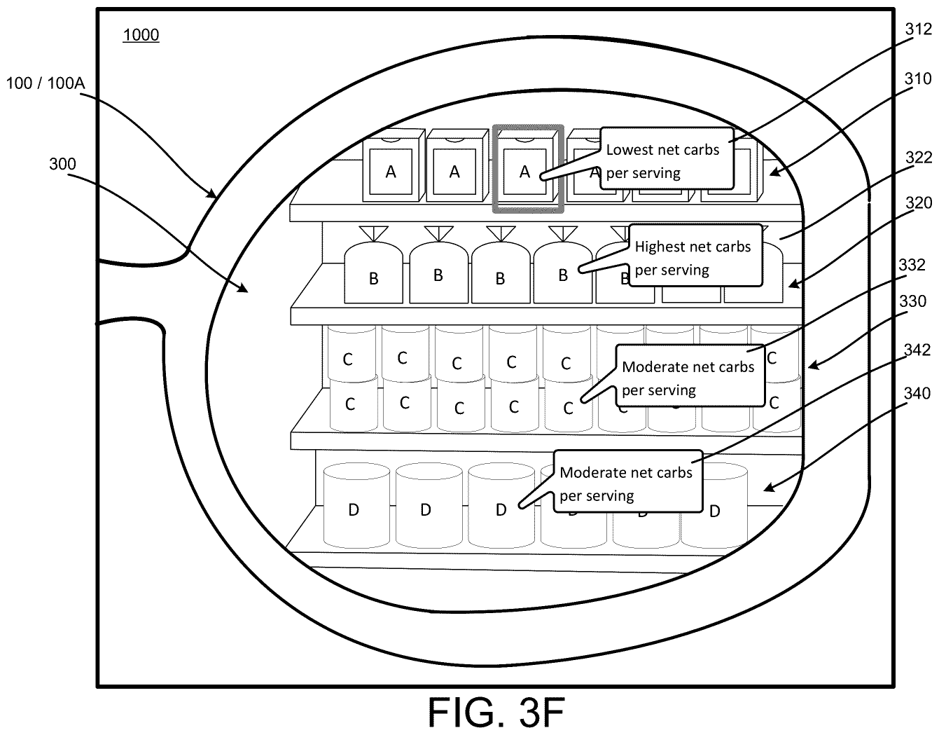

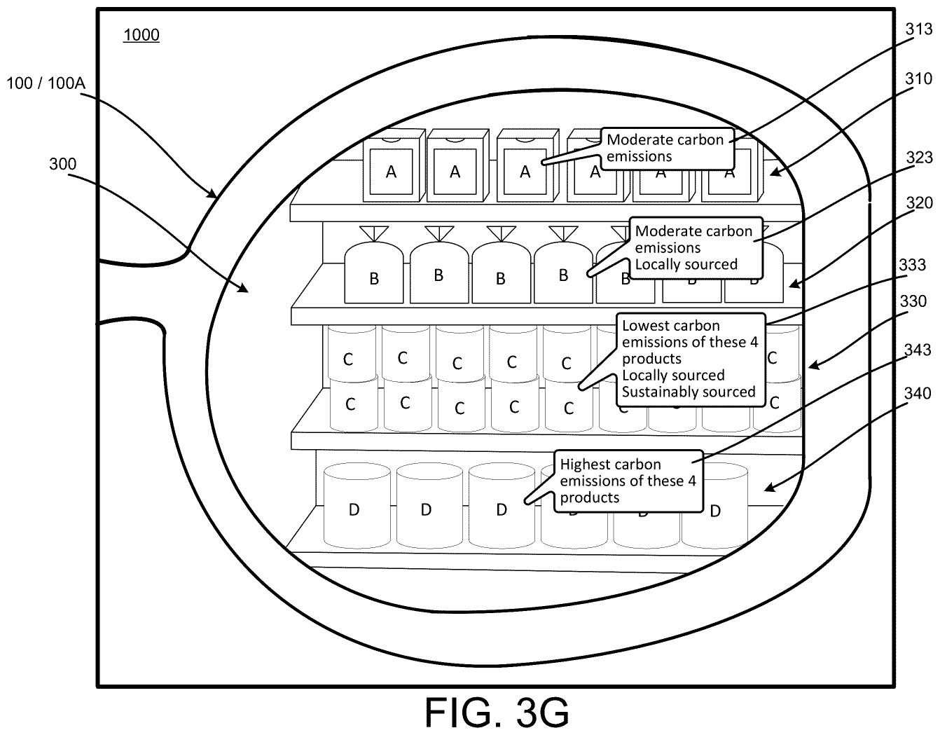

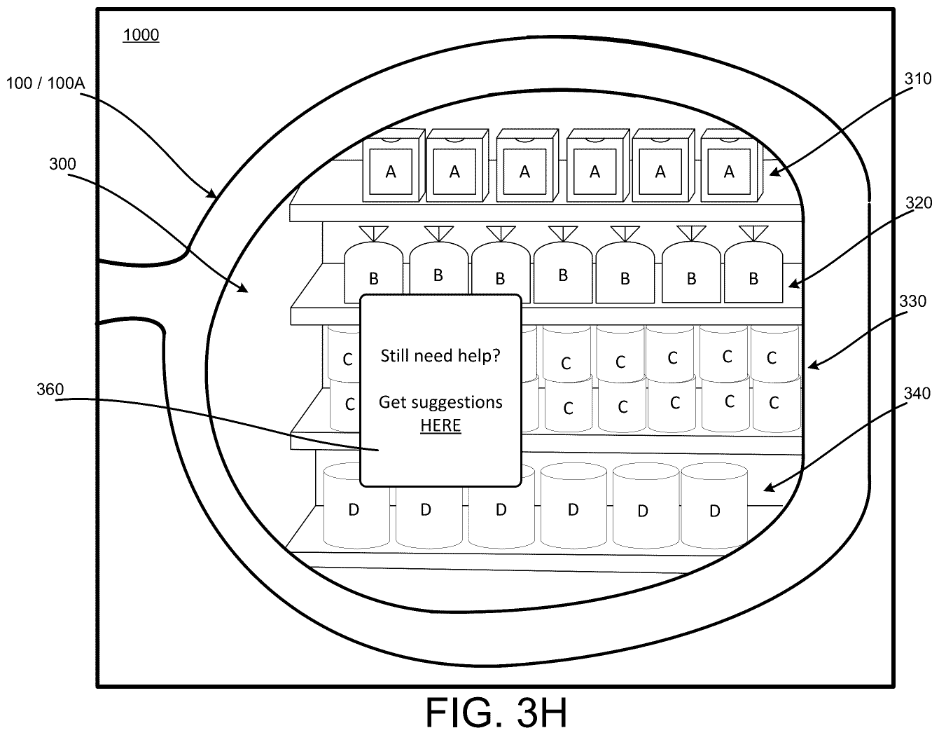

FIGS. 3A-3H illustrate operation of a system and method, in accordance with implementations described herein, in which objects and/or entities and the like in a physical environment may be detected and identified, and information related to the objects and/or entities may be provided to the user. The information may provide for a comparison of common characteristics of the objects and/or entities, allowing the user to make an informed decision in taking further action related to the objects and/or entities. In the example shown in FIGS. 3A-3H, the system and method is conducted by the user via a head mounted wearable computing device in the form of a pair of smart glasses, simply for purposes of discussion and illustration. The principles to be described herein can be applied to the use of other types of computing devices. Similarly, in the example shown in FIGS. 3A-3H, the system and method is described with respect to a plurality of products available to the user for purchase, simply for purposes of discussion and illustration. The principles to be described herein can be applied to other objects and/or entities in which additional information would facilitate an informed decision by the user.

FIG. 3A illustrates a user in the physical environment 1000, approaching an example arrangement 300 of example products. In the view shown in FIG. 3A, at least a portion of the example arrangement 300 of example products is captured within the field of view of the outward facing image sensor 116 of the computing device 100A (i.e., in the form of the example smart glasses) worn by the user. FIG. 3B illustrates the example arrangement 300 of example products as viewed by the user through the lens portion of the computing device 100A. In the example shown in FIGS. 3A and 3B, the example arrangement 300 of products includes a first product 310, a second product 320, a third product 330 and a fourth product 340, simply for purposes of discussion and illustration. The first, second, third and fourth products 310, 320, 330, 340 may represent, for example, assorted brands of similar/related products, different sizes, different packaging, different variations (i.e., flavors, colors, and the like) of the same/similar type of product, and the like.

In some situations, it may be beneficial to the user to have ready access to additional information related to objects and/or entities and the like that are visible to the user, such as, for example, the products 310, 320, 330, 340 as shown in FIG. 3B. The user may take the additional information into consideration in making an informed decision related to further action with respect to the objects and/or entities. For example, the user may take the additional information into consideration when deciding which of the products 310, 320, 330, 340 may meet the user's needs and/or be best suited to the user, which of the products 310, 320, 330, 340 to purchase, and the like.

In some examples, images captured by the outward facing image sensor 116 of the computing device 100A may be used to identify the objects and/or entities within the field of view of the outward facing image sensor 116. In the example shown in FIGS. 3A and 3B, the products 310, 320, 330, 340 may be identified based on, for example, image recognition and/or text recognition from the product labeling. In some examples, the products 310, 320, 330, 340 may be identified based on a current detected location of the user/the computing device 100A (for example, a particular retail establishment in this example), together with, for example, recognition of product packaging, known location within the retail establishment, and the like. In some examples, identification of the products 310, 320, 330, 340 may be performed based on information accessible locally on the computing device 100A (for example, the additional resources 210 described above with respect to FIG. 2). In some examples, the images captured by the outward facing image sensor 116 may be transmitted to a resource that is external to the computing device 100A. For example, the objects may be processed by a recognition engine and/or a search engine (for example, provided in the additional resources 210 described above with respect to FIG. 2), for processing and identification of the products 310, 320, 330, 340.

In some examples, the identification of the products 310, 320, 330, 340 captured within the field of view of the outward facing image sensor 116 of the computing device 100A may be conducted in response to detection of an identification condition that triggers identification of the products 310, 320, 330, 340. In some examples, the identification condition may include detection of a gaze directed at the products 310, 320, 330, 340 that has a duration that is greater than or equal to a preset threshold duration/preset amount of time. In some examples, the detection of the gaze may be detection of an eye gaze detected, for example, by the gaze detection device 120 of the computing device 100A. In some examples, detection of the gaze may be detection of fixation on the arrangement 300 of the group of products 310, 320, 330, 340 based on consistency in the grouping of products 310, 320, 330, 340 captured within the field of view of the outward facing image sensor 116 for greater than or equal to the preset threshold duration/preset amount of time. In some examples, the identification condition may be triggered in response to a user input. The user input may include, for example, a touch input detected at a touch input portion of the computing device 100A, a gesture input detected based on images captured by the outward facing image sensor 116, an audible input detected by the audio input device 107 (and transcribed into an executable command input by, for example a transcription engine included in the additional resources 210 as described above with respect to FIG. 2), an input received via another device that is paired with, or in communication with the computing device 100A, and other such user inputs.

The view illustrated in FIG. 3C includes virtual objects, superimposed at corresponding positions on the user's view of the physical products 310, 320, 330, 340 in the physical environment 1000. The virtual objects provide for the output of information related to the identified products 310, 320, 330, 340. In particular, the virtual objects may provide for the output of information that allows for comparison of common characteristics associated with the multiple physical products 310, 320, 330, 340. In the example shown in FIG. 3C, the common characteristic of the physical products 310, 320, 330, 340 that is provided for comparison is rating information. The rating information may provide a measurement standard for comparison of the products 310, 320, 330, 340 by the user, based on data obtained, for example, through searches conducted for ratings of the physical products 310, 320, 330, 340.

In the example shown in FIG. 3C, a virtual object 311 provides rating information related to the first product 310, a virtual object 321 provides rating information related to the second product 320, a virtual object 331 provides rating information related to the third product 330, and a virtual object 341 provides rating information related to the fourth product 340. The product rating information output via the virtual objects 311, 321, 331, 341 may provide for a comparison of at least one common characteristic associated with the products 310, 320, 330, 340 (in this example, consumer rating information for each of the products 310, 320, 330, 340). In some examples, the virtual objects 311, 321, 331, 341 providing product related information may be triggered for output (i.e., display by the display device 104 of the computing device 100A, output by the audio output device 106 of the computing device 100A, and the like) in response to a detected output condition including a specific user input or user request (for example, a specific user request for consumer product rating information), a gaze directed at the products 310, 320 330, 340 having a duration of greater than or equal to a set threshold duration, and the like. In some examples, the virtual objects 311, 321, 331, 341 providing product related information may be triggered for output (in this example, triggered for display by the display device 104 of the computing device 100A) based on a set hierarchy for display of product related information. In some examples, the virtual objects 311, 321, 331, 341 providing product related information may be triggered for display based on set user preferences. In some examples, the virtual objects 311, 321, 331, 341 providing product related information may be triggered for display based on historical usage associated with a particular user. The additional information displayed via the virtual objects 311, 321, 331, 341 may be available locally, on the computing device 100A. In some examples, the additional information may be obtained based on a search conducted by, for example, a search engine available to the computing device 100A via the additional resources 210 described above with respect to FIG. 2.

In some examples, the computing device 100A may output the product information to the user in the form of audio signals (for example, via the audio output device(s) 106 of the computing device 100A), in addition to or instead of the virtual objects 311, 321, 331, 341 displayed to the user.

In some examples, the virtual objects 311, 321, 331, 341 may be output in an anticipatory manner, without a specific input or request from the user. In some examples, images captured by the outward facing camera 116 of the computing device 100A including the arrangement 300 of products 310, 320, 330, 340 on shelves, may be processed (for example, by the recognition engine) to determine that the user is in a retail establishment. This determination may be made based on image recognition alone or together with location data associated with the current location of the computing device 100A, not necessarily relying on the detection and tracking of user gaze. In some examples, the computing device 100A may output a prompt to the user, prior to displaying the virtual objects 311, 321, 331, 341, to confirm that the user wants product related information, would like to do a product comparison, and the like, prior to outputting product related information. The example prompt 355 shown in FIG. 3B shown in FIG. 3B is output by the computing device 100A in the form of a virtual object displayed to the user by the display device 104, for purposes of discussion and illustration. In some examples, the prompt may be, for example, an audible signal output by the audio output device 106 of the computing device 100A. In this example, the computing device 100A may output the information related to the products 310, 320, 330, 340 (for example, in the form of the example virtual objects 311, 321, 331, 341 as shown) in response to a user input in one of the numerous forms described above (i.e., a touch input, an audible input, a gesture input and the like input at the computing device 100A and/or an external device in communication with the computing device 100A).

In FIG. 3E, the virtual objects 311, 321, 331, 341 have been modified to output additional information related to the product ratings provided in FIG. 3C. This additional information may allow the user to further discern amongst the products 310, 320, 330, 340, and/or may cause the user to further explore consumer product reviews. In some examples, this additional information may be provided in response to a user request for additional information related to the product ratings, such as, for example, an audible user input, a touch input, a gesture input and the like. In some examples, the additional information related to the product ratings may be provided in response to detection of a sustained gaze or dwell time on the rating information shown in FIG. 3C that is greater than or equal to a set threshold time or duration. In some examples, a user input requesting additional information may be provided in response to a prompt 350 displayed to the user, as shown in FIG. 3D. In some examples, the additional information related to the product ratings may be provided in response to a detected user input, in the form of, for example, a touch input, a gesture input, an audible input (detected by the audio input device 107 and transcribed by, for example a transcription engine as described above with respect to the additional resources 210 available to the computing device 100A), and other such user inputs.

The related product information provided to the user via the virtual objects 311, 321, 331, 341 in this manner provides a compilation of rating information for the specific products 310, 320, 330, 340 within the current field of view of the user. In this example, this product information is provided to the user without the need for separate, user initiated searches for each of the individual products 310, 320, 330, 340. Thus, the product information provided to the user in this manner may facilitate user selection of one or more of the products 310, 320, 330, 340, allowing the user to make an informed decision quickly and easily.

The view illustrated in FIG. 3F includes virtual objects 312, 322, 332, 342, superimposed at corresponding positions on the user's view of the physical products 310, 320, 330, 340 in the physical environment 1000. The virtual objects 312, 322, 332, 342 provide for the output of information related to the identified products 310, 320, 330, 340. In the example shown in FIG. 3F, the virtual objects 312, 322, 332, 342 provide nutritional information that is of specific interest to this particular user. The nutritional information output via the virtual objects 312, 322, 332, 342 may provide for a comparison of a common characteristic associated with the products 310, 320, 330, 340 (in this example, nutritional information for each of the products 310, 320, 330, 340). In this example, the user may be interested in controlling, or reducing, or eliminating specific elements from their diet. In some examples, the additional information (i.e., the nutritional information, in this example) may be obtained based on a search conducted by, for example, a search engine available to the computing device 100A via the additional resources 210 described above with respect to FIG. 2 and provided to the computing device 100A. Thus, in the example shown in FIG. 3F, the common characteristic of the physical products 310, 320, 330, 340 that is provided for comparison is the nutritional information. The nutritional information may provide a quantitative measurement standard based on the composition of the products, for comparison of the products 310, 320, 330, 340 by the user.

As described above, in some examples, the information provided via the virtual objects 312, 322, 332, 342 may be provided in response to a specific user input or a specific user request. The specific user input or request may be, for example, a touch input, a gesture input, an audible input and the like that is detected and processed by the computing device 100A for output of the virtual objects 312, 322, 332, 342 including the requested product information. In some examples, the information provided via the virtual objects 312, 322, 332, 342 may be provided based on known user preferences, known user history and the like. In some examples, the information provided via the virtual objects 312, 322, 332, 342 may be provided by the system proactively, in an anticipatory manner, without the need for specific user prompting or requests.

In some examples, the system may highlight one or more of the products determined to be most suitable for the user based on, for example, set user preferences, stored user data such as, for example, data associated with the user's previous purchase history, purchase history associated with the user's established family group, and the like. In the example shown in FIG. 3F, the product 310 is highlighted. The information displayed via the virtual objects 312, 322, 332, 342 may be available locally, on the computing device 100A and/or may be accessible to the computing device 100A from an external resource. This product related information may be provided to the user in a proactive, anticipatory manner. The product related information is provided to the user without the need for separate, user initiated searches for each of the individual products 310, 320, 330, 340 and/or manual comparison of the products within the retail establishment, thus facilitating user selection of one or more of the products 310, 320, 330, 340.

As noted above, in some examples, one or more products may be highlighted or suggested based on, for example, stored user data and/or user preferences. In some examples, the stored user data may include, for example, previous purchase history. In the example shown in FIG. 3H, the product 310 may be highlighted based on previous purchases of the product 310 by the user. In some examples, the product 310 may be highlighted based on previous purchases of the product 310 by a group of users connected to the user. In some examples, the group of users may be, for example, a family group with which the user is associated. In some examples, the group of users may be, for example, another type of group with which the user is associated, such as, for example, via social media and the like. In some examples, in addition to highlighting the product 310, the system may output a prompt (not shown) indicating that the product 310 is most frequently purchased by a particular user in the previously established user group, by a number of users connected to the user via one or more social media outlets, and the like. Thus, in some examples, the highlighting of the product 310 as shown may indicate to the user that the product 310 is the one (of the products 310, 320, 330, 340 being compared) most frequently purchased by the user and/or one or more groups associated with the user.

The view illustrated in FIG. 3G includes virtual objects 313, 323, 333, 343, superimposed at corresponding positions on the user's view of the physical products 310, 320, 330, 340 in the physical environment 1000. The virtual objects 313, 323, 333, 343 provide for the output of information related to the identified products 310, 320, 330, 340. In the example shown in FIG. 3G, the virtual objects 313, 323, 333, 343 provide information related to the production practices associated with the products 310, 320, 330, 340 that is of specific interest to this particular user. The production practices information output via the virtual objects 313, 323, 333, 343 may provide for a comparison of a common characteristic associated with the products 310, 320, 330, 340 (in this example, production practices information for each of the products 310, 320, 330, 340). In some examples, this type of information may be gathered by a search engine that accesses external resources to obtain the information specific to the products 310, 320, 330, 340 identified. In some examples, this type of information is obtained in an anticipatory manner, based on user preferences, known user history and the like. In some examples, this information is obtained in response to a user input such as, for example, a touch input, a gesture input, an audible command issued by the user and transcribed into an executable command input, and the like.

In this example, the production practices associated with each of the products 310, 320, 330, 340 may be of great importance to the user in selecting one or more of the products 310, 320, 330, 340 for purchase. In this example, separate searches for this type of information related to these individual products would otherwise be time consuming and cumbersome to execute in real time, particularly while in the retail establishment with the intention of using this information to make an informed decision regarding product selection and purchase. The system and method, in accordance with implementations described herein, provides for this type of information to be searched, compiled and summarized for the identified products 310, 320, 330, 340, and presented to the user, in real time.

In FIG. 3H, a prompt 360 is output, or displayed. The prompt 360 provides the user with access to further information related to the products 310, 320, 330, 340 that can be analyzed by the user in making an informed purchase decision.

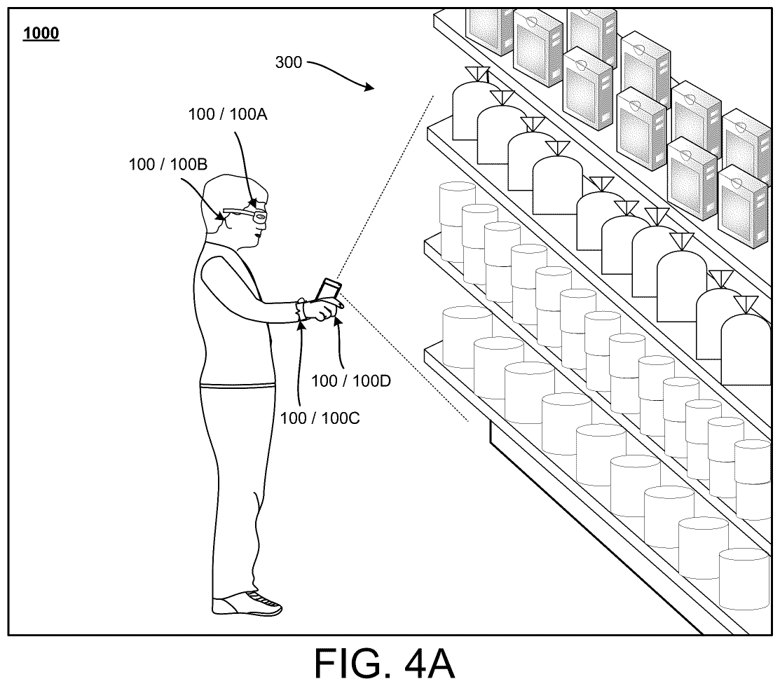

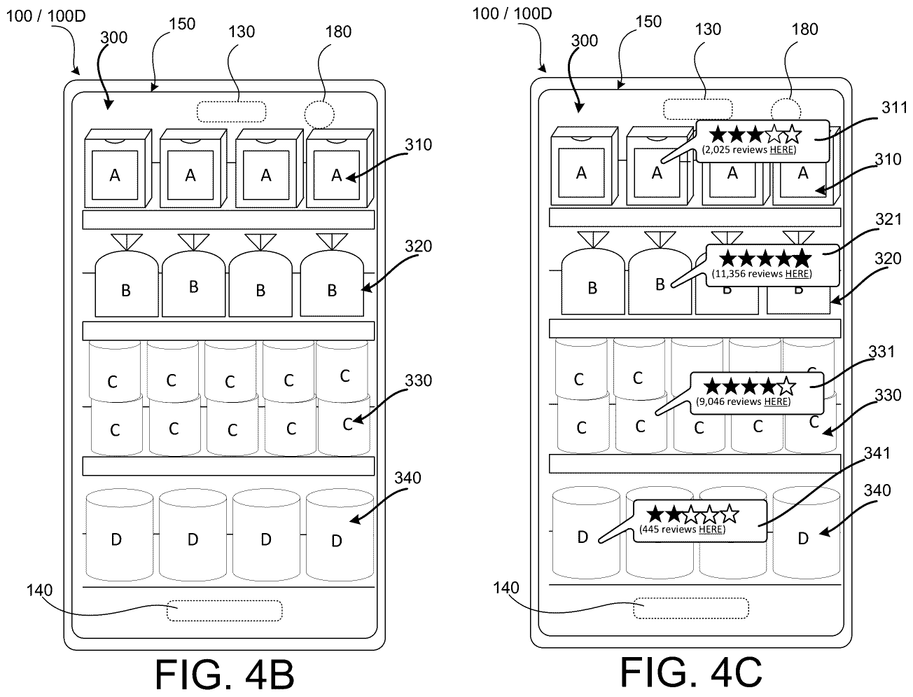

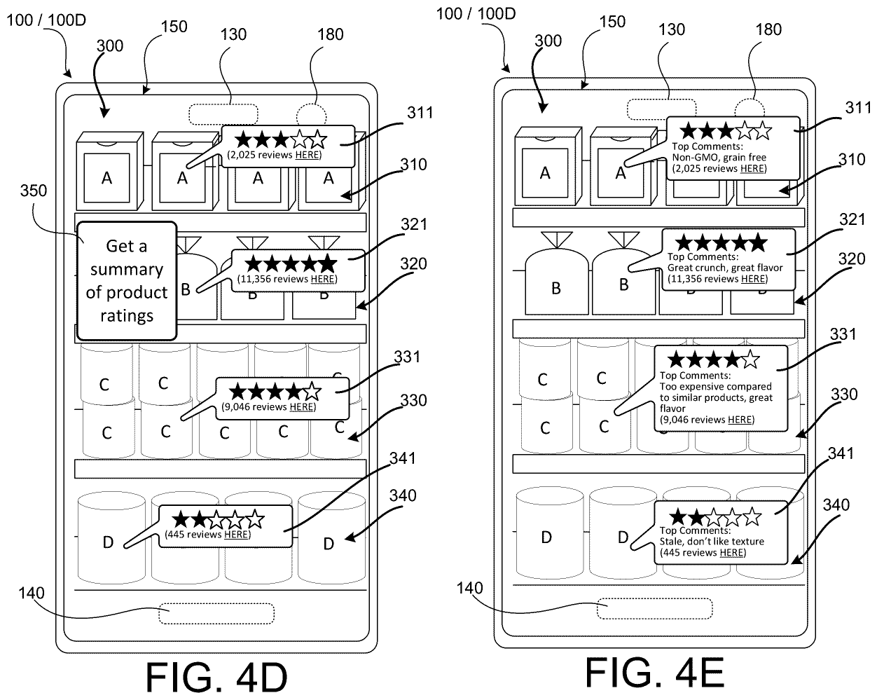

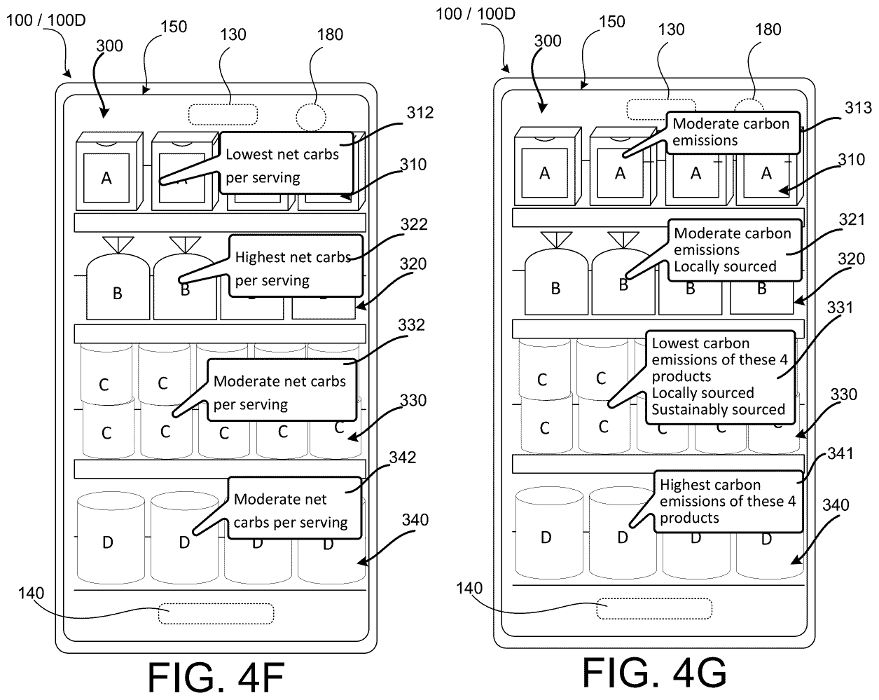

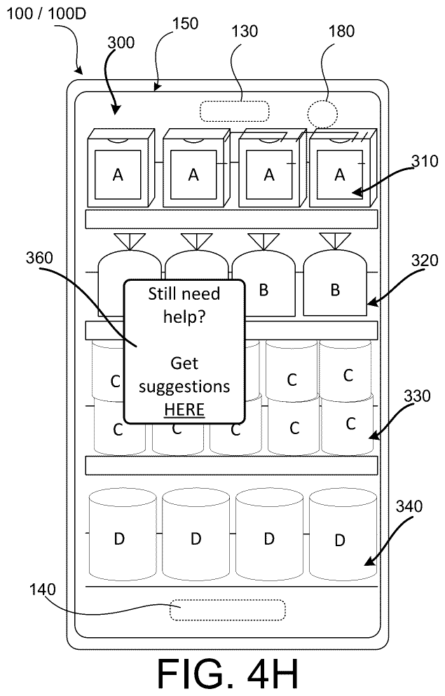

FIG. 4A illustrates the user in the physical environment 1000, approaching the example arrangement 300 of example products 310, 320, 330, 340. In the view shown in FIG. 4A, at least a portion of the example arrangement 300 of products 310, 320, 330, 340 is captured within the field of view of the outward facing image sensor of the computing device 100D (i.e., in the form of the example smart phone) held by the user. FIG. 4B illustrates the example arrangement 300 of products 310, 320, 330, 340 as viewed by the user on the interface device 150 of the computing device 100A (in particular the display portion 152 of the interface device 150). As with the example described above with respect to FIGS. 3A and 3B, the example arrangement 300 of products 310, 320, 330, 340 may represent, for example, different brands of similar/related products, different sizes, different packaging, different variations (i.e., flavors, colors, and the like) of the same/similar type of product, and the like.

Images captured by the outward facing image sensor 180 of the computing device 100D may be used to identify the objects and/or entities within the field of view of the outward facing image sensor. as described above, the products 310, 320, 330, 340 may be identified based on, for example, image recognition and/or text recognition from the product labeling, based on a current detected location of the user/the computing device 100D, recognition of product packaging, known location within the retail establishment, and the like, either locally on the computing device 100A or based on information provided by a source that is external to the computing device 100D.

As described above, the identification of the products 310, 320, 330, may be conducted in response to detection of an identification condition. In some examples, the identification condition may include detection of the products 310, 320, 330, 340 captured within the field of view of the outward facing image sensor for a duration that is greater than or equal to a preset threshold duration/preset amount of time. In some examples, the identification condition may be triggered in response to a user input including, for example, a touch input detected at the touch input portion 154 of the interface device 150 of the computing device 100D, a gesture input detected based on data provided by a position/acceleration sensor of the computing device 100D, an audible input detected by the audio input device 140, and other such user inputs.

In FIG. 4C, the virtual objects 311, 321, 331, 341 are displayed on the display portion 152 of the interface device 150 of the computing device 100D, at positions corresponding to the respective products 310, 320, 330, 340 in the image of the physical environment 1000 displayed on the display portion 152. Display of the product related rating information may be triggered for display in response to a specific user input or user request, based on a set hierarchy for display of product related information, based on set user preferences, based on historical usage associated with a particular user, and the like. The information displayed via the virtual objects 311, 321, 331, 341 may be available locally, on the computing device 100D and/or may be accessible to the computing device 100D from an external resource.

In FIG. 4E, the virtual objects 311, 321, 331, 341 have been modified to include additional information related to the product ratings provided in FIG. 4C that may allow the user to further discern amongst the products 310, 320, 330, 340, and/or may cause the user to further explore consumer product reviews. In some examples, this additional information may be provided in response to a user request for additional information related to the product ratings, such as, for example, an audible user input, a touch input, a gesture input and the like. In some examples, a user input requesting additional information may be provided in response to the prompt 350 displayed to the user, as shown in FIG. 4D.

The related product information provided to the user via the virtual objects 311, 321, 331, 341 displayed on the display portion 152 of the user interface device 150 of the computing device 100D in this manner provides a compilation of rating information for the specific products 310, 320, 330, 340 within the current field of view of the computing device 100D. In this example, this product information is provided to the user without the need for separate, user initiated searches for each of the individual products 310, 320, 330, 340. Thus, the product information provided to the user in this manner may facilitate user selection of one or more of the products 310, 320, 330, 340, allowing the user to make an informed decision quickly and easily.

The view illustrated in FIG. 4F includes the virtual objects 312, 322, 332, 342, displayed at positions on the display portion 152 of the interface device 150 corresponding to the respective physical product 310, 320, 330, 340. As in the example described above, the virtual objects 312, 322, 332, 342 provide nutritional information that is of specific interest to this particular user. The information provided via the virtual objects 312, 322, 332, 342 may be provided in response to a specific user input or a specific user request in the form of, for example, a touch input, a gesture input, an audible input and the like. In some examples, the information provided via the virtual objects 312, 322, 332, 342 may be provided based on known user preferences, known user history and the like, without the need for specific user prompting or requests. The information displayed via the virtual objects 312, 322, 332, 342 may be available locally, on the computing device 100D and/or may be accessible to the computing device 100D from an external resource. This product related information is provided to the user without the need for separate, user initiated searches for each of the individual products 310, 320, 330, 340 and/or manual comparison of the products within the retail establishment, thus facilitating user selection of one or more of the products 310, 320, 330, 340.

The view illustrated in FIG. 4G includes the virtual objects 313, 323, 333, 343 displayed at positions corresponding to the respective products 310, 320, 330, 340, providing information related to the production of the products 310, 320, 330, 340 that is of specific interest to this particular user. In this example, separate searches for this type of information related to these individual products would otherwise be time consuming and cumbersome to execute real time, particularly while in the retail establishment with the intention of using this information to make an informed decision regarding product selection and purchase. The system and method, in accordance with implementations described herein, provides for this type of information to be searched, compiled and summarized for the identified products 310, 320, 330, 340, and presented to the user, in real time.

In FIG. 4H, the prompt 360 is output, or displayed on the display portion 152 of the interface device 150, facilitating user access to further information related to the products 310, 320, 330, 340 that can be analyzed by the user in making an informed purchase decision.

The examples provided above are described with respect to the use of the first computing device 100A (in the form of a head mounted wearable device including processing and display capability, such as smart glasses), and with respect to the user of the fourth computing device 100D (in the form of a handheld computing device including processing and display capability, such as a smart phone), simply for purposes of discussion and illustration. The principles described herein can be applied to other types of devices including processing capability and display capability, having access to additional resources for the identification of objects and/or entities in the physical environment 1000, and for access to additional information related to the identified objects and/or entities.

The examples provided above are described with respect to a product purchase/product comparison/commerce application, simply for purposes of discussion and illustration. The principles described herein can be applied to other situations in which comparison data is useful to the user selecting one of a plurality of alternatives. For example, the principles described herein may be applied to the comparison and selection of various different types of service providers, or entities, such, for example, as transit options, dining establishments, entertainment options, and the like. For example, in comparing a plurality of dining establishments, a comparison of common characteristics may include, for example

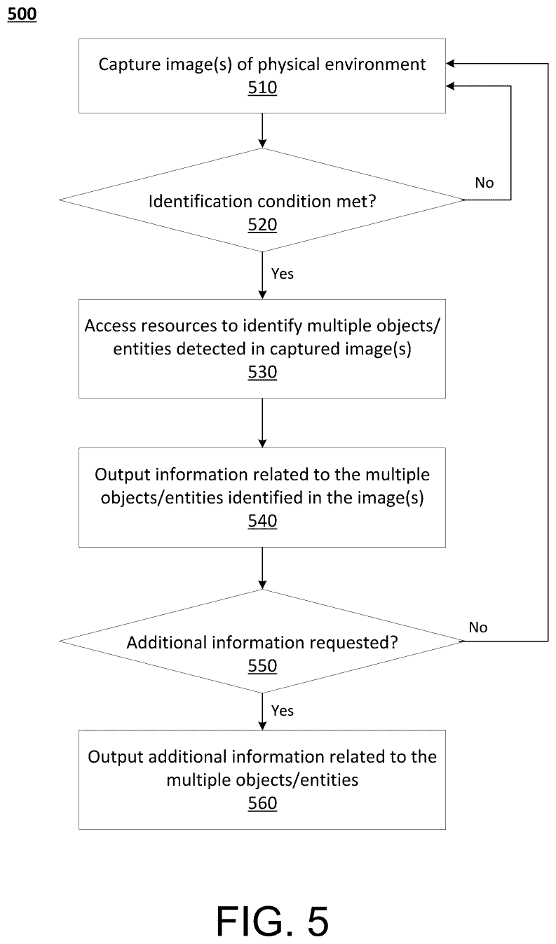

FIG. 5 is a flowchart of an example method 500 for accessing and providing information related to objects and/or entities in the physical environment, in accordance with implementations described herein. The method may be implemented by a computing device having processing and display capability, and access to information facilitating the identification of the objects and/or entities, and to information related to the identified objects and/or entities.

The computing device (for example, the first computing device 100A or the fourth computing device 100D as described in the examples above, or another computing device having processing and display capability) may capture images including multiple objects and/or entities in the physical environment (block 510). In response to detection of an identification condition (block 520), the computing device may access resources providing for the identification of multiple objects and/or entities captured in the images (block 530). The identification condition may be, for example, detection of a sustained gaze or focus of an image sensor of the computing device on a particular arrangement of objects/entities, detection of a user input, and the like. The resources for identifying the multiple objects and/or entities in the physical environment may be available locally on the computing device and/or may be provided to the computing device from external resources accessible via a network. The external resources may include, for example, a recognition engine having access to one or more databases, a search engine, and the like. The computing device may output information related to the identified objects and/or entities (block 540). The information may be available locally on the computing device and/or may be provided to the computing device from external resources in communication with the computing device via a network. In some examples, the information may be obtained by a search engine conducting a search of one or more databases to obtain the information provided to the computing device. In some implementations, the information may be output to a user of the computing device via a display device of the computing device. In some implementations, the information may be output to the user via an audio output device of the computing device. Additional information related to the identified objects/entities may be retrieved and output to the user (block 560) in response to a request for additional information (block 550). The additional information may be available locally on the computing device and/or may be provided to the computing device from external resources, such as, for example, one or more search engines and one or more databases as noted above, via a network. The request for additional information may be detected in response to a user input, based on known user preferences, based on known user history, and the like.

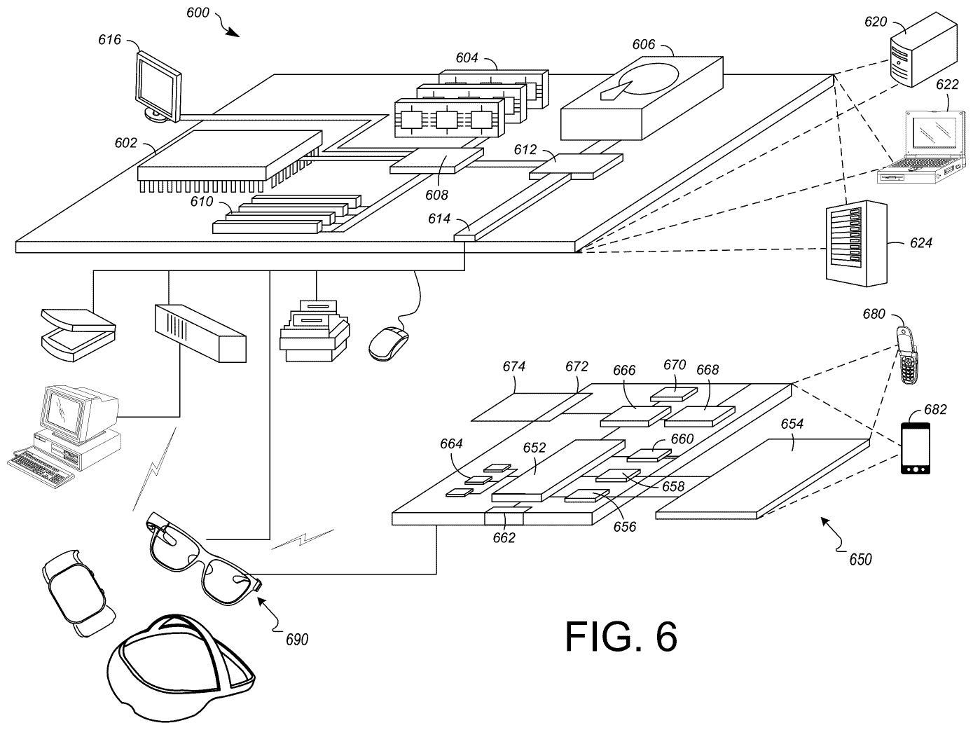

FIG. 6 illustrates an example of a computer device 600 and a mobile computer device 650, which may be used with the techniques described here. The computing device 600 includes a processor 602, memory 604, a storage device 606, a high-speed interface 608 connecting to memory 604 and high-speed expansion ports 610, and a low-speed interface 612 connecting to low-speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high-speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high-speed controller 608 manages bandwidth-intensive operations for the computing device 600, while the low-speed controller 612 manages lower bandwidth-intensive operations. Such allocation of functions is example only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display), and LED (Light Emitting Diode) or an OLED (Organic Light Emitting Diode) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In-Line Memory Module) card interface. Such expansion memory 674 may provide extra storage space for device 650, or may also store applications or other information for device 650. Specifically, expansion memory 674 may include instructions to conduct or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652, that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, Wi-Fi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device 690 to generate an augmented environment for viewing inserted content within the physical space. For example, one or more sensors included on a computing device 650 or other computing device depicted in the figure, can provide input to the AR headset 690 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 650 can use the sensors to determine an absolute position and/or a detected rotation of the computing device in the AR space that can then be used as input to the AR space. For example, the computing device 650 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 650 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 650 when the computing device is incorporated into the AR space can cause a particular action to occur in the AR space.

In some implementations, a touchscreen of the computing device 650 can be rendered as a touchpad in AR space. A user can interact with the touchscreen of the computing device 650. The interactions are rendered, in AR headset 690 for example, as movements on the rendered touchpad in the AR space. The rendered movements can control virtual objects in the AR space.

In some implementations, one or more output devices included on the computing device 650 can provide output and/or feedback to a user of the AR headset 690 in the AR space. The output and feedback can be visual, tactile, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 650 may appear as another object in a computer-generated, 3D environment. Interactions by the user with the computing device 650 (e.g., rotating, shaking, touching a touchscreen, swiping a finger across a touch screen) can be interpreted as interactions with the object in the AR space. In the example of the laser pointer in an AR space, the computing device 650 appears as a virtual laser pointer in the computer-generated, 3D environment. As the user manipulates the computing device 650, the user in the AR space sees movement of the laser pointer. The user receives feedback from interactions with the computing device 650 in the AR environment on the computing device 650 or on the AR headset 690. The user's interactions with the computing device may be translated to interactions with a user interface generated in the AR environment for a controllable device.

In some implementations, a computing device 650 may include a touchscreen. For example, a user can interact with the touchscreen to interact with a user interface for a controllable device. For example, the touchscreen may include user interface elements such as sliders that can control properties of the controllable device.

Computing device 600 is intended to represent various forms of digital computers and devices, including, but not limited to laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A computer-implemented method, comprising:
capturing, by an image sensor of a computing device, image data of a physical environment;
obtaining, from a recognition engine in communication with the computing device, identification of a plurality of physical objects detected in the image data;
obtaining, from a search engine in communication with the computing device, values for a quantifiable common characteristic of the plurality of physical objects identified in the image data; and
outputting, by an output system of the computing device, at least one virtual object on a user view of physical environment, the at least one virtual object displaying the values for the quantifiable common characteristic of the plurality of physical objects identified in the image data, the values providing a comparison of the quantifiable common characteristic of the plurality of physical objects identified in the image data.

2. The computer-implemented method of claim 1, wherein obtaining the identification of the plurality of physical objects detected in the image data includes:
detecting an identification condition; and
transmitting the image data to an external system via a network in response to the identification condition, wherein the recognition engine is provided at the external system, the external system having access to a plurality of databases from which the recognition engine obtains identifying information associated with the plurality of physical objects.

3. The computer-implemented method of claim 2, wherein detecting the identification condition includes at least one of:
detecting a gaze directed at the plurality of physical objects having a duration that is greater than or equal to a set threshold; or
detecting, by the computing device or an external device that is in communication with the computing device, a user input initiating identification of the plurality of physical objects, the user input including at least one of an audible input detected by an audio sensor of the computing device or the external device, a touch input detected by a touch sensor of the computing device or the external device, or a gesture input detected by at least one of an image sensor or a position sensor of the computing device or the external device.

4. The computer-implemented method of claim 2, wherein outputting the values of the quantifiable common characteristic of the plurality of physical objects identified in the image data includes:
detecting an output condition; and
generating, for display by a display device of the computing device, a plurality of virtual objects including the values providing the comparison of the quantifiable common characteristic of the plurality of physical objects in response to the output condition, wherein the values included in the plurality of virtual objects are obtained by at least one search engine of the external system based on the identifying information associated with the plurality of physical objects.

5. The computer-implemented method of claim 4, wherein detecting the output condition and outputting the values includes:
detecting a first user input setting the quantifiable common characteristic for comparison;
detecting a second user input requesting output of the values providing the comparison of the quantifiable common characteristic of the plurality of physical objects; and
displaying the plurality of virtual objects in response to the second user input.

6. The computer-implemented method of claim 5, wherein the first user input and the second user input are audible inputs detected by an audio sensor of the computing device and transcribed, by a transcription engine in communication with the computing device, into a command that is executable by the computing device.

7. The computer-implemented method of claim 4, wherein detecting the output condition and outputting the values includes:
setting the quantifiable common characteristic based on at least one of set user preferences or known user data;
detecting a gaze directed at the plurality of physical objects;
detecting a duration of the gaze that is greater than or equal to a set threshold; and
displaying the plurality of virtual objects in response to detecting the duration of the gaze that is greater than or equal to the set threshold.

8. The computer-implemented method of claim 1, wherein outputting the values for the quantifiable common characteristic of the plurality of physical objects includes:
setting the quantifiable common characteristic for comparison of the plurality of physical objects; and
triggering for display, by a display device of the computing device, a first plurality of virtual objects respectively corresponding to the plurality of physical objects, the first plurality of virtual objects displaying the values for the quantifiable common characteristic of the plurality of physical objects for comparison of the quantifiable common characteristic of the plurality of physical objects.

9. The computer-implemented method of claim 8, wherein setting the quantifiable common characteristic includes at least one of:
setting the quantifiable common characteristic in response to a user input selecting the quantifiable common characteristic;
setting the quantifiable common characteristic based on set preferences for a user of the computing device; or
setting the quantifiable common characteristic based on known user data associated with the user of the computing device.

10. The computer-implemented method of claim 8, further comprising:
receiving, from an external system, the values for the quantifiable common characteristic of the plurality of physical objects for comparison of the quantifiable common characteristic of the plurality of physical objects, wherein the values of the quantifiable common characteristic are obtained by at least one search engine of the external system having access to at least one database; and
generating, for display by a display device of the computing device, the plurality of virtual objects, the first plurality of virtual objects displaying the values for the quantifiable common characteristic obtained by the at least one search engine for comparison of the quantifiable common characteristic of the plurality of physical objects.

11. (canceled)

12. The computer-implemented method of claim 1, wherein outputting the values for the quantifiable common characteristic related to the plurality of physical objects includes:
setting the quantifiable common characteristic for comparison of the plurality of physical objects; and
outputting, by an audio output device of the computing device, an audio signal including the values for the quantifiable common characteristic related to the plurality of physical objects for comparison of the quantifiable common characteristic of plurality of objects.

13. The computer-implemented method of claim 1, wherein the computing device is a head mounted wearable computing device, or a handheld computing device.

14. A system, comprising:
a computing device, including:
a display device;
at least one processor; and
a memory storing instructions that, when executed by the at least one processor, cause the at least one processor to:
capture, by an image sensor of a computing device, image data of a physical environment;
obtain, from a recognition engine in communication with the computing device, identification of a plurality of physical objects detected in the image data;
obtain, from a search engine in communication with the computing device, values for a quantifiable common characteristic of the plurality of physical objects identified in the image data; and
output, by an output system of the computing device, at least one virtual object on a user view of physical environment, the at least one virtual object displaying the values for the quantifiable common characteristic of the plurality of physical objects identified in the image data, the values providing a comparison of the quantifiable common characteristic of the plurality of physical objects identified in the image data.

15. The system of claim 14, wherein the instructions cause the at least one processor to:
detect an identification condition;
transmit the image data to an external system in response to the identification condition, wherein the recognition engine is provided at the external system, the external system having access to a plurality of databases including identifying information associated with the plurality of physical objects; and
obtain the identifying information associated with the plurality of physical objects detected in the images image data from the external system.

16. The system of claim 15, wherein of the instructions cause the at least one processor to detect the identification condition including at least one of:
detect a gaze directed at the plurality of physical objects having a duration that is greater than or equal to a set threshold; or
detect, by the computing device or an external device in communication with the computing device, a user input initiating identification of the plurality of physical objects, the user input including at least one of an audible input detected by an audio sensor of the computing device or the external device, a touch input detected by a touch sensor of the computing device or the external device, or a gesture input detected by at least one of an image sensor or a position sensor of the computing device or the external device.

17. The system of claim 15, wherein the instructions cause the at least one processor to output the values for the quantifiable common characteristic of the plurality of physical objects identified in the image data including:
detect an output condition; and
generate, for display by the display device, a plurality of virtual objects including the values providing the comparison of the quantifiable common characteristic of the plurality of physical objects in response to the output condition,
wherein the values included in the plurality of virtual objects is obtained by at least one search engine of the external system based on the identifying information associated with the plurality of physical objects.

18. The system of claim 17, wherein the instructions cause the at least one processor to detect the output condition and to output the values, including:
detect a first user input setting the quantifiable common characteristic for comparison;
detect a second user input requesting output of the values providing the comparison of the quantifiable common characteristic of the plurality of physical objects; and
display the plurality of virtual objects in response to the second user input.

19. The system of claim 18, wherein the first user input and the second user input are audible inputs detected by an audio sensor of the computing device and transcribed, by a transcription engine in communication with the computing device, into a command that is executable by the at least one processor of the computing device.

20. The system of claim 17, wherein the instructions cause the at least one processor to detect the output condition and to output the identifying information, including:
set the quantifiable common characteristic based on at least one of set user preferences or known user data;
detect a gaze directed at the plurality of physical objects;
detect a duration of the gaze that is greater than or equal to a set threshold; and
display the plurality of virtual objects in response to detecting the duration of the gaze that is greater than or equal to the set threshold.

21. A non-transitory computer-readable medium storing executable instructions that, when executed by at least one processor of a computing system, are configured to cause the at least one processor to:
capture, by an image sensor of a computing device of the computing system, image data of a physical environment;
obtain, from a recognition engine in communication with the computing device, identification of a plurality of physical objects detected in the image data;
obtain, from a search engine in communication with the computing device, values for a quantifiable common characteristic of the plurality of physical objects identified in the image data; and
output, by an output system of the computing device, at least one virtual object on a user view of physical environment, the at least one virtual object displaying the values for the quantifiable common characteristic of the plurality of physical objects identified in the image data, the values providing a comparison of the quantifiable common characteristic of the plurality of physical objects identified in the image data.

22. The non-transitory computer-readable medium of claim 21, wherein the executable instructions cause the at least one processor to:
detect an identification condition;
transmit the image data to the recognition engine in response to the identification condition, wherein the recognition engine is provided external to the computing device, the recognition engine accessing a plurality of databases including identifying information associated with the plurality of physical objects;
obtain the identification of the plurality of physical objects detected in the image data from the recognition engine;
detect an output condition; and
generate, for display by a display device of the computing device, a plurality of virtual objects including the values providing the comparison of the quantifiable common characteristic of the plurality of physical objects in response to the output condition,
wherein the values included in the plurality of virtual objects are obtained by at least one search engine that is external to the computing device based on the identifying information associated with the plurality of physical objects.

23. The non-transitory computer-readable medium of claim 22, wherein the executable instructions cause the at least one processor to:
detect the identification condition including at least one of:
detect a gaze directed at the plurality of physical objects having a duration that is greater than or equal to a set threshold; or
detect, by the computing device or an external device in communication with the computing device, a user input initiating identification of the plurality of physical objects, the user input including at least one of an audible input detected by an audio sensor of the computing device or the external device, a touch input detected by a touch sensor of the computing device or the external device, or a gesture input detected by at least one of an image sensor or a position sensor of the computing device or the external device; and
detect the output condition and to output the identifying information, including:
detect a first user input setting the quantifiable common characteristic for comparison;
detect a second user input requesting output of the values providing the comparison of the
quantifiable common characteristic of the plurality of physical objects; and
display the plurality of virtual objects in response to the second user input.
